(19) United States
(12) Patent Application Publication
(10) Pub. No.: US 2010/0128971 A1
(43) Pub. Date: May 27, 2010

(54) Image processing apparatus, image processing method and computer-readable recording medium

(75) Inventors: Toshiyuki Kamiya, Osaka-shi (JP); Hiroyuki Yagyuu, Osaka (JP); Hirokazu Koizumi, Osaka (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC System Technologies, Ltd., Osaka (JP)

(21) Appl. No.: 12/292,762

(22) Filed: Nov. 25, 2008

(51) Int. Cl. G06K 9/00

(52) U.S. Cl. 382/154; 382/282; 382/201

(57) ABSTRACT

A pair of images subjected to image processing is divided. Next, based on mutually-corresponding divided images, mutually-corresponding matching images are respectively set. When a corresponding point of a characteristic point in one matching image is not extracted from the other matching image, adjoining divided images are joined together, and based on the joined divided image, a new matching image is set.

### BACKGROUND OF THE INVENTION

1. Field of the Invention

The present invention relates to an image processing apparatus, an image processing method and a computer-readable recording medium.

2. Description of the Related Art

Often used in the field of terrain analysis or the like is a technique of calculating three-dimensional information, such as the shape of a land, the position of a building, and the height thereof, by performing a stereo matching process on a pair of images obtained by shooting from different viewpoints (see Japanese Patent Publication No. H8-16930). The stereo matching process is a process of extracting a characteristic point, e.g., a point that corresponds to a corner of a building in an image or a portion that abruptly protrudes from a ground surface, in one of two images, and a corresponding point in the other image using an image correlation technique, and of acquiring three-dimensional information including the positional information of an object and the height information thereof, based on the extracted characteristic point and the positional information of the corresponding point.

According to the stereo matching process, when a process-target image is an image obtained by shooting, for example, an urban area where there are lots of clusters of high-rise buildings, the number of characteristic points in one image becomes too large. Accordingly, in order to reduce the time necessary for the process, there is proposed a technique of dividing each of two paired images into plural images, and of performing a stereo matching process on each divided image (hereinafter simply called divided image) (Information Processing Society of Japan, National Lecture Collected Paper, Vol. 64th, No. 4 (see, PAGE, 4.767 to 4.770)).

According to the technique of performing a stereo matching process on each divided image, because the amount of data handled is small for each stereo matching process, the process for one pair of images can be carried out in a short time. However, in regard to the upper part of a high-rise object like a high-rise building, the parallax increases between the pair of process-target images. In some cases, a divided image may not include a corresponding point corresponding to a characteristic point of the other divided image, which is in a corresponding relationship with the former divided image. In this case, it is difficult to perform a stereo matching process, or the process result will be insufficient.

### SUMMARY OF THE INVENTION

The present invention has been made in view of the foregoing circumstances, and it is an object of the present invention to realize improvement of a process precision while speeding up an image processing.

An image processing apparatus according to the first aspect of the present invention an image processing apparatus that performs a stereo matching process on a first image and a second image picked up at mutually different positions, the apparatus comprising:

a setting unit that respectively divides the first image and the second image into plural images, and sets a divided image of the first image and a divided image of the second image, which corresponds to the divided image of the first image, as a first matching image and a second matching image, respectively;

an extracting unit that extracts a corresponding point corresponding to a point in the first matching image and included in the second matching image;

a resetting unit that resets one joined image, which is obtained by joining a divided image set as the first matching image with a different divided image adjoined thereby, as a first matching image and resets another joined image, which is obtained by joining a divided image set as the second matching image with a different divided image adjoined thereby, as a second matching image, when the extracting unit cannot extract the corresponding point; and

a calculating unit that calculates three-dimensional information of a point included in the matching image of the first image and a corresponding point included in the matching image of the second image.

An image processing apparatus according to the second aspect of the invention is an image processing apparatus that performs a stereo matching process on a first image and a second image picked up at mutually different positions, the apparatus comprising:

a setting unit that respectively divides the first image and the second image into plural images, and sets a divided image of the first image and a margin area therearound, and a divided image of the second image, which corresponds to the divided image of the first image, and a margin area therearound, as a first matching image and a second matching image, respectively;

an extracting unit that extracts a corresponding point corresponding to a point in the first matching image and included in the second matching image;

a resetting unit that resets one joined image, which is obtained by joining a divided image included in the first matching image with a different divided image adjoined thereby, and a margin area surrounding the one joined image as a first matching image and resets another joined image, which is obtained by joining a divided image included in the second matching image with a different divided image adjoined thereby, and a margin area surrounding the another joined image as a second matching image, when the extracting unit cannot extract the corresponding point; and

a calculating unit that calculates three-dimensional information of a point included in the first matching image, and a corresponding point included in the second matching image.

An image processing method according to the third aspect of the invention is an image processing method that performs a stereo matching process on a first image and a second image picked up at mutually different positions, the method comprising:

a step of dividing the first image and the second image into plural images, respectively, and setting a divided image of the first image and a divided image of the second image, which corresponds to the divided image of the first image, as a first matching image and a second matching image, respectively;

a step of extracting a corresponding point corresponding to a point in the first matching image and included in the second matching image;

a step of resetting one joined image, which is obtained by joining a divided image set as the first matching image with a different divided image adjoined thereby, as a first matching image and resetting another joined image, which is obtained by joining a divided image set as the second matching image with a different divided image adjoined thereby, as a second matching image, when the extracting unit cannot extract the corresponding point; and

a step of calculating three-dimensional information of a point included in the matching image of the first image, and a corresponding point included in the matching image of the second image.

An image processing method according to the fourth aspect of the invention is an image processing method that performs a stereo matching process on a first image and a second image picked up at mutually different positions, the method comprising:

a step of dividing the first image and the second image into plural images, respectively, and setting a divided image of the first image and a margin area therearound, and a divided image of the second image, which corresponds to the divided image of the first image, and a margin area therearound, as a first matching image and a second matching image, respectively;

a step of extracting a corresponding point corresponding to a point in the first matching image and included in the second matching image;

a step of resetting one joined image, which is obtained by joining a divided image included in the first matching image with a different divided image adjoined thereby, and a margin area surrounding the one joined image as a first matching image and resetting another joined image, which is obtained by joining a divided image included in the second matching image with a different divided image adjoined thereby, and a margin area surrounding the another joined image as a second matching image, when the extracting unit cannot extract the corresponding point; and

a step of calculating three-dimensional information of a point included in the first matching image, and a corresponding point included in the second matching image.

A computer-readable recording medium according to the fifth aspect of the invention is a computer-readable recording medium storing a program that allows a computer to function as:

a setting unit that respectively divides a first image and a second image into plural images, the first and second images being picked up at mutually different positions, and sets a divided image of the first image and a divided image of the second image, which corresponds to the divided image of the first image, as a first matching image and a second matching image, respectively;

an extracting unit that extracts a corresponding point corresponding to a point in the first matching image and included in the second matching image;

a resetting unit that resets one joined image, which is obtained by joining a divided image set as the first matching image with a different divided image adjoined thereby, as a first matching image and resets another joined image, which is obtained by joining a divided image set as the second matching image with a different divided image adjoined thereby, as a second matching image, when the extracting unit cannot extract the corresponding point; and

a calculating unit that calculates three-dimensional information of a point included in the matching image of the first image, and a corresponding point included in the matching image of the second image.

A computer-readable recording medium according to the sixth aspect of the invention is a computer-readable recording medium storing a program that allows a computer to function as:

a setting unit that respectively divides a first image and a second image into plural images, the first and second images being picked up at mutually different positions, and sets a divided image of the first image and a margin area therearound, and a divided image of the second image, which corresponds to the divided image of the first image, and a margin area therearound, as a first matching image and a second matching image, respectively;

an extracting unit that extracts a corresponding point corresponding to a point in the first matching image and included in the second matching image;

a resetting unit that resets one joined image, which is obtained by joining a divided image included in the first matching image with a different divided image adjoined thereby, and a margin area surrounding the one joined image as a first matching image and resets another joined image, which is obtained by joining a divided image included in the second matching image with a different divided image adjoined thereby, and a margin area surrounding the another joined image as a second matching image, when the extracting unit cannot extract the corresponding point; and

a calculating unit that calculates three-dimensional information of a point included in the first matching image, and a corresponding point included in the second matching image.

According to the present invention, a stereo matching process on a pair of different images can be performed at a short time and precisely.

### BRIEF DESCRIPTION OF THE DRAWINGS

The object and other objects and advantages of the present invention will become more apparent upon reading of the following detailed description and the accompanying drawings in which:

FIG. 1 is a block diagram showing a stereo image processing apparatus according to one embodiment of the present invention;

FIG. 2 is a diagram for explaining image data;

FIG. 3A is a (first) diagram showing an image as image data;

FIG. 3B is a (second) diagram showing an image as image data;

FIG. 4A is a (first) diagram showing a matching image on the basis of a divided image;

FIG. 4B is a (second) diagram showing a matching image on the basis of a divided image;

FIG. 5A is a (first) diagram showing a matching image on the basis of a divided image;

FIG. 5B is a (second) diagram showing a matching image on the basis of a divided image;

FIG. 6A is a (first) diagram showing a matching image on the basis of a combined image;

FIG. 6B is a (second) diagram showing a matching image on the basis of a combined image;

FIG. 7 is a flowchart showing the operation of the stereo image processing apparatus;

FIG. 8A is a (first) diagram for explaining a modified example of a stereo image processing;

FIG. 8B is a (second) diagram for explaining a modified example of a stereo image processing; and

FIG. 9 is a block diagram showing a physical structural example when the stereo image processing apparatus is implemented by a computer.

### DETAILED DESCRIPTION OF THE PREFERRED EMBODIMENTS

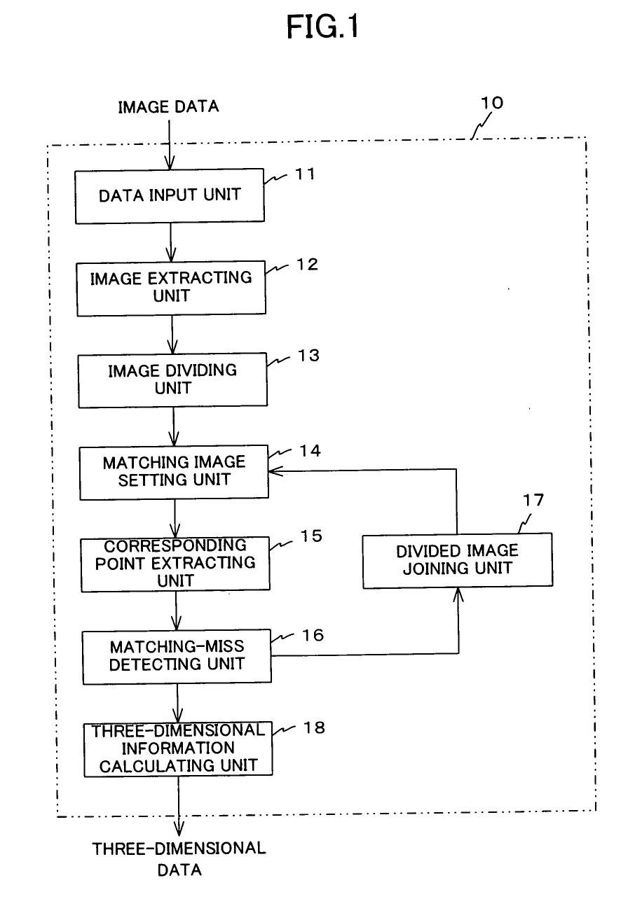

Hereinafter, an explanation will be given of an embodiment of the present invention with reference to FIGS. 1 to 7. FIG. 1 is a block diagram of a stereo image processing apparatus 10 according to the embodiment. As shown in FIG. 1, the stereo image processing apparatus 10 comprises a data input unit 11, an image extracting unit 12, an image dividing unit 13, a matching image setting unit 14, a corresponding point extracting unit 15, a matching-miss detecting unit 16, a divided image joining unit 17, and a three-dimensional information calculating unit 18.

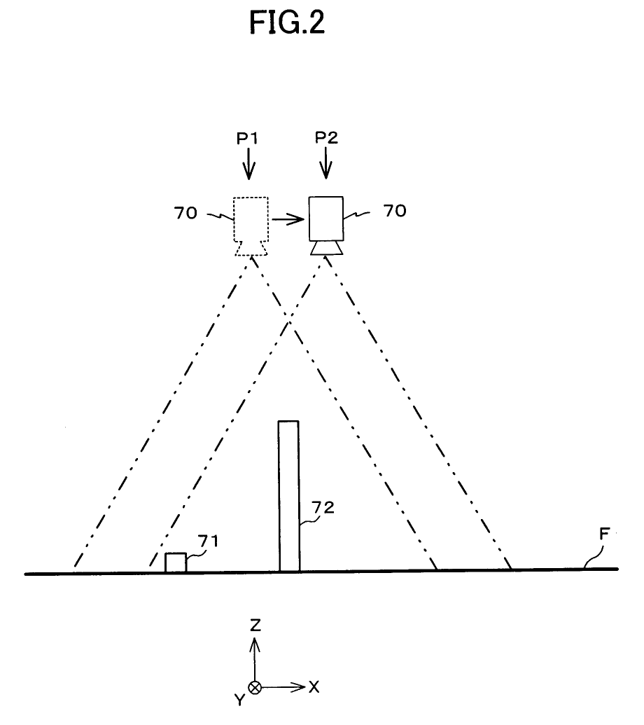

Image data is input from an external apparatus or the like, such as an image pick up device to the data input unit 11. The image data is a picked-up image obtained by, for example, shooting a ground surface by the image pick up device or the like. In the embodiment, an explanation will be given of a case where, as shown in FIG. 2 as an example, two images, obtained by shooting an area over a ground surface F including a building 71 and a building 72 while moving a camera in the X-axis direction, are input. Moreover, for the ease of explanation, let us suppose that the optical axis of a digital camera 70 at a position P1 indicated by a dotted line in FIG. 2 and the optical axis of the digital camera 70 at a position P2 indicated by a continuous line are parallel to each other and that the epipolar line is consistent between the two images.

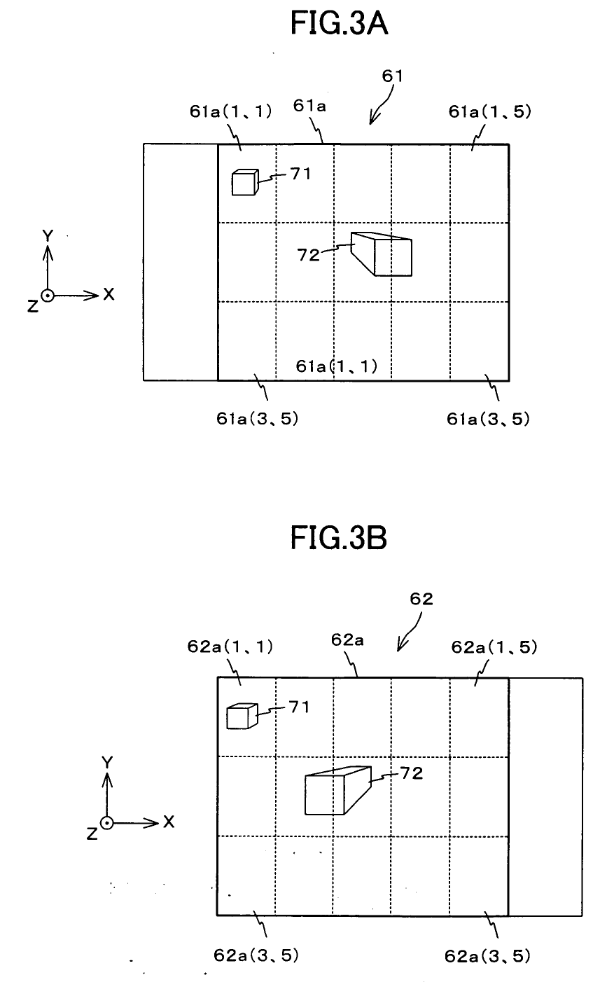

The image extracting unit 12 detects an overlapping area from each of a pair of images, and extracts an image corresponding to this area from each of the pair of images. As an example, FIG. 3A shows an image 61 picked up by the digital camera 70 at the position P1, and FIG. 3B shows an image 62 picked up by the digital camera 70 at the position P2, which is on the +X side of the position P1. The image extracting unit 12 compares the image 61 with the image 62, and extracts extracted images 61a and 62a, respectively, from the images 61 and 62 having a mutually common area.

The image dividing unit 13 divides each of the extracted image 61a extracted from the image 61 and the extracted image 62a extracted from the image 62 into block images disposed in a matrix with three rows and five columns. Hereinafter, an n-th block image of the extracted image 61a at m-th row will be denoted as 61a (m, n), and an n-th block image of the extracted image 62a at m-th row will be denoted as 62a (m, n).

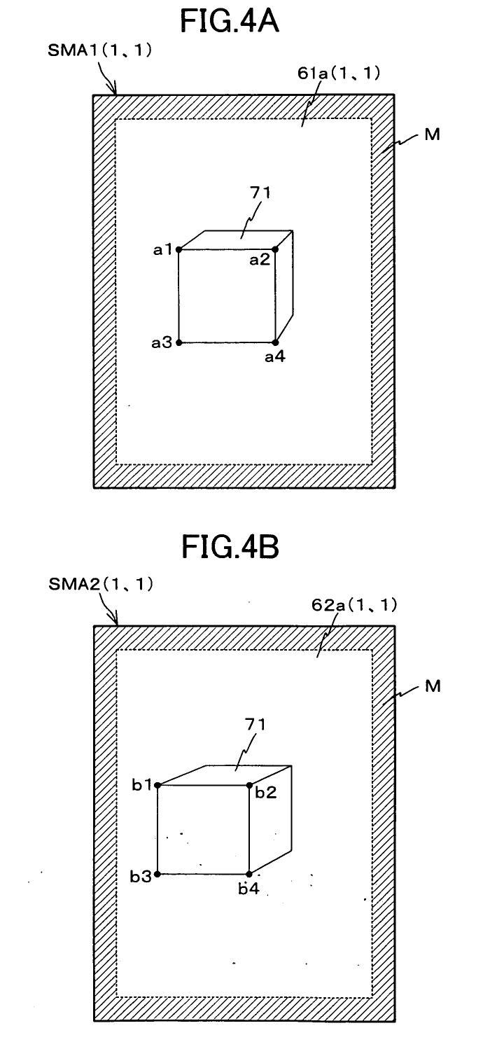

The matching image setting unit 14 sets matching images mutually corresponding to each other on the basis of the block image 61a (m, n) of the extracted image 61a and the block image 62a (m, n) of the extracted image 62a. For example, in order to set a matching image based on the block image 61a (1, 1) and the block image 62a (1, 1), as can be seen in FIG. 4A and FIG. 4B, the matching image setting unit 14 adds margin areas M to the surroundings of the respective block image 61a (1, 1) and block image 62a (1, 1). Then, the matching image setting unit 14 sets an area including the block image 61a (1, 1) and the margin area M as a matching image SMA1 (1, 1) subjected to a stereo matching process, and sets an area including the block image 62a (1, 1) and the margin area M as a matching image SMA2 (1, 1). Afterward the matching image setting unit 14 performs the same process on a block image 61a (1, 2) to a block image 61a (3, 5), and a block image 62a (1, 2) to a block image 62a (3, 5).

The margin area M is set in such a way that a corresponding point to a characteristic point is included in a matching image corresponding to a matching image including the characteristic point when there is a parallax between the characteristic point and the corresponding point. Accordingly, if the greater the margin area, the larger the parallax between the characteristic point and the corresponding point, which are included in corresponding matching images.

The corresponding point extracting unit 15 extracts a corresponding point mutually corresponding to a characteristic point included in a matching image SMA1 (m, n) and included in a matching image SMA2 (m, n). This process is carried out by an image correlation technique or the like that checks a correlation between a tiny area in a matching image SMA1 (m, n) and a tiny area in a matching image SMA2 (m, n).

For example, as can be seen in FIG. 4A and FIG. 4B, the corresponding point extracting unit 15 extracts points b1 to b4 included in a matching image SMA2 (1, 1) as corresponding points corresponding to characteristic points a1 to a4 of the building 71 included in a matching image SMA1 (1, 1).

The matching-miss detecting unit 16 determines whether or not corresponding points corresponding to characteristic points in a matching image SMA1 (m, n) are all present in a matching image SMA2 (m, n).

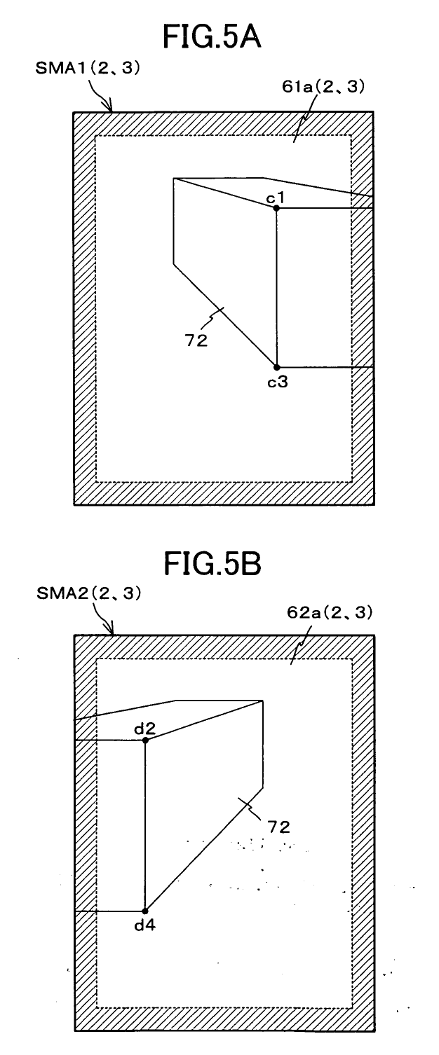

For example, as can be seen in FIG. 4A and FIG. 4B, the matching-miss detecting unit 16 determines that extraction of corresponding points is succeeded if all corresponding points b1 to b4 corresponding to characteristic points a1 to a4 included in a matching image SMA1 (1, 1) are included in a matching image SMA2 (1, 1). On the other hand, as can be seen in FIG. 5A and FIG. 5B, the matching-miss detecting unit 16 determines that extraction of corresponding points is unsuccessful if only characteristic points c1 and c3 among characteristic points c1 to c4 of the building 72 are included in a matching image SMA1 (2, 3) and corresponding points d1 and d3 corresponding to the characteristic points c1 and c3 of the building 72 are not included in a matching image SMA2 (2, 3).

The three-dimensional information calculating unit 18 calculates the three-dimensional information of a characteristic point in a matching image SMA1 and a corresponding point extracted from a matching image SMA2 and corresponding to the characteristic point. More specifically, for example, three-dimensional information (DSM (Digital Surface Map) data) including the heights of the buildings 71, 72 or the like is created using, for example, the positions of a characteristic point and a corresponding point with a view point of the digital camera 70 positioned at the position P1 being as an origin, and a technique used for triangular surveying.

The divided image joining unit 17 joins a block image, adjoining with each other in the X-axis direction which is a direction in which there is a parallax between the image 61 and the image 62, with a block image included in a matching image that a miss is detected, when the matching detecting unit 16 detects a matching-miss, thereby defining a new block image of the image 61 and the image 62.

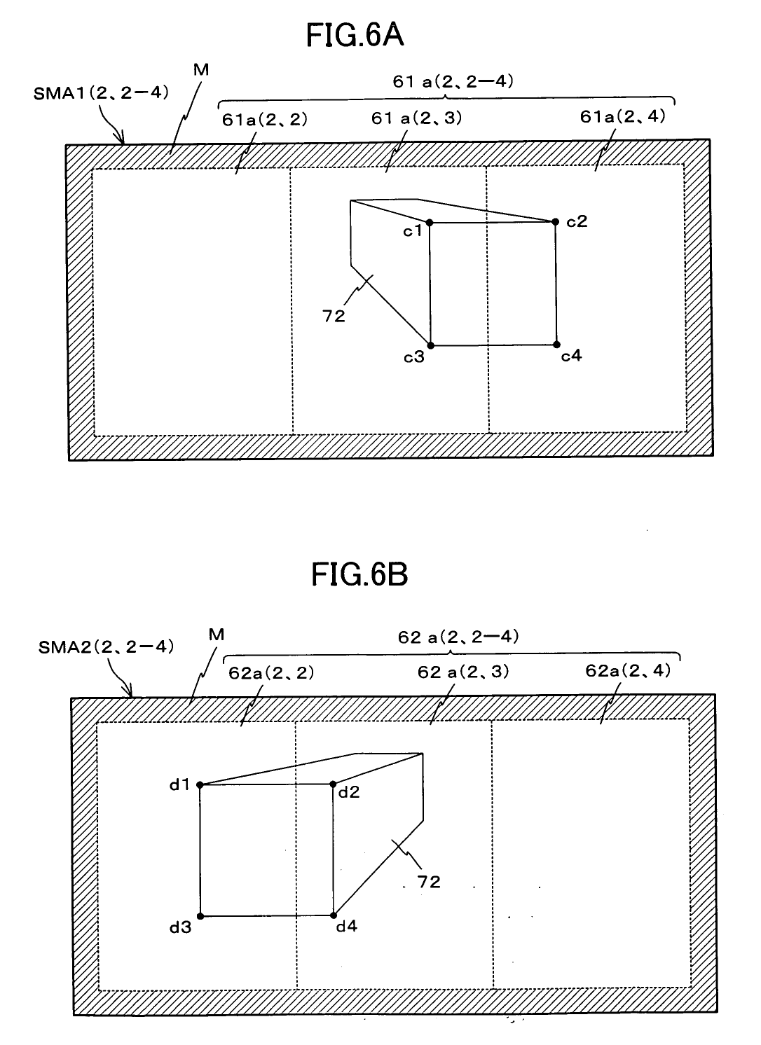

For example, as can be seen in FIG. 6A and FIG. 6B, the divided image joining unit 17 joins a block image 61a (2, 3) with a block image 61a (2, 2), which is on the −X side of the block image 61a (2, 3), and a block image 61a (2, 4), which is on the +X side of the block image 61a (2, 3), in order to define a new block image 61a (2, 2-4). Moreover, it joins a block image 62a (2, 3) with a block image 62a (2, 2), which is on the −X side of the block image 62a (2, 3), and a block image 62a (2, 4), which is on the +X side of the block image 62a (2, 3), in order to define a new block image 62a (2, 2-4).

When the divided image joining unit 17 defines a block image, the matching image setting unit 14 resets a matching image based on the block image.

For example, as can be seen in FIG. 6A and FIG. 6B, the matching image setting unit 14 adds the margin areas M to the surroundings of the respective block image 61a (2, 2-4) and block image 62a (2, 2-4). Thereafter, the matching image setting unit 14 sets an area including the block image 61a (2, 2-4) and the margin area M as a matching image SMA1 (2, 2-4) subjected to a stereo matching process, and sets an area including the block image 62a (2, 2-4) and the margin area M as a matching image SMA2 (2, 2-4) subjected to a stereo matching process.

Moreover, the corresponding point extracting unit 15 extracts a corresponding point corresponding to a characteristic point included in the matching image SMA1 (2, 2-4) and included in the matching image SMA2 (2, 2-4) as the matching image SMA1 (2, 2-4) and the matching image SMA2 (2, 2-4) are set.

As can be seen in FIG. 6A and FIG. 6B, as corresponding points corresponding to characteristic points c1 to c4 of the building 72 included in the matching image SMA1 (2, 2-4), points d1 to d4 included in the matching image SMA2 (2, 2-4) are extracted. In this case, because all corresponding points of the characteristic points c1 to c4 included in the matching image SMA1 (2, 2-4) are included in the matching image SMA2 (2, 2-4), the matching-miss detecting unit 16 detects no matching-miss.

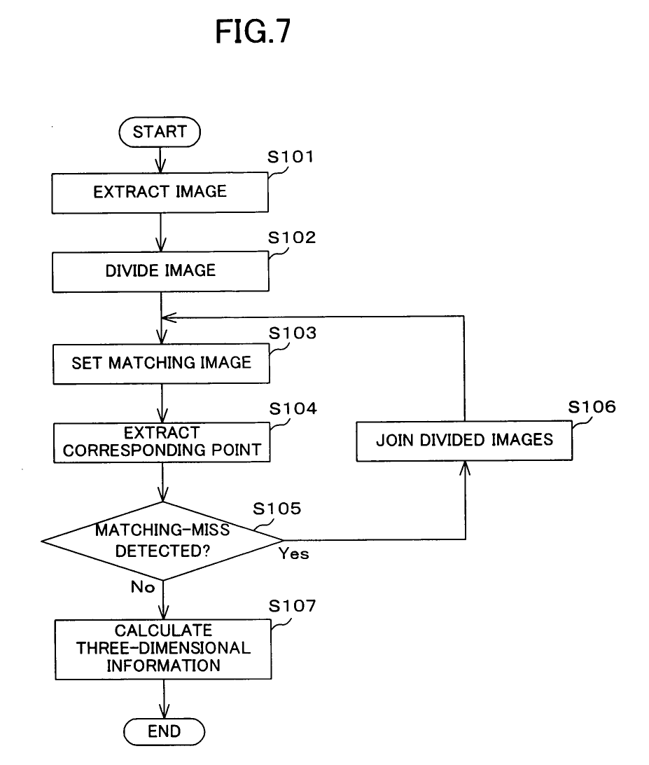

Next, the operation of the stereo image processing apparatus 10 will be explained with reference to the flowchart shown in FIG. 7. As image data is input into the data input unit 11, the stereo image processing apparatus 10 starts the successive processes shown in the flowchart of FIG. 7.

In a first step S101, the image extracting unit 12 extracts the images 61a, 62a corresponding to mutually overlapping areas from the image 61 and the image 62 input into the data input unit 11.

In a next step S102, the image dividing unit 13 divides the extracted images 61a and 62a into block images 61a (m, n) and 62a (m, n), respectively.

In a next step S103, the matching image setting unit 14 adds the margin areas M to the respective block images 61a (m, n) and 62a (m, n), and sets matching images SMA1 and SMA2.

In a next step S104, the corresponding point extracting unit 15 extracts a corresponding point corresponding to a characteristic point in the matching image SMA1 and included in the matching image SMA2.

In a next step S105, the matching-miss detecting unit 16 detects any matching-miss on the basis of the fact whether or not corresponding points of characteristic point included in the matching image SMA1 are all included in the corresponding matching image SMA2. When a matching-miss is detected, a process at a step S106 is executed, and when no matching-miss is detected, a process at a step S107 is executed.

In the step S106, the divided image joining unit 17 joins a block image contained in a matching image that a miss is detected with a block image adjoining in the X-axis direction which is a direction in which a parallax is present between the image 61 and the image 62, thereby defining a new block image.

In the step S107, the three-dimensional information calculating unit 18 creates three-dimensional information (DSM data) on the basis of the positional information of a characteristic point in the matching image SMA1 and a corresponding point extracted from SMA2 and corresponding to the characteristic point.

As explained above, according to the embodiment, based on the block image 61a (m, n) and the block image 62a (m, n), mutually-corresponding matching image SMA1 and matching image SMA2 are set. When a corresponding point of a characteristic point in the matching image SMA1 is not extracted from the matching image SMA2, block images 61a (m, n) adjoining in a direction in which a parallax occurs are joined together, so that new block images 61a (m, (n−1)-(n+1)) and 62a (m, (n−1)-(n+1)) are defined, and based on those block images 61a (m, (n−1)-(n+1)), and 62a (m, (n−1)-(n+1)), a matching image SMA1 and a matching image SMA2 are reset. Accordingly, a characteristic point and a corresponding point are to be included in mutually-corresponding matching images. Therefore, when a stereo matching process for the image 61 and the image 62 is also performed on each divided image, it is possible to execute the process precisely.

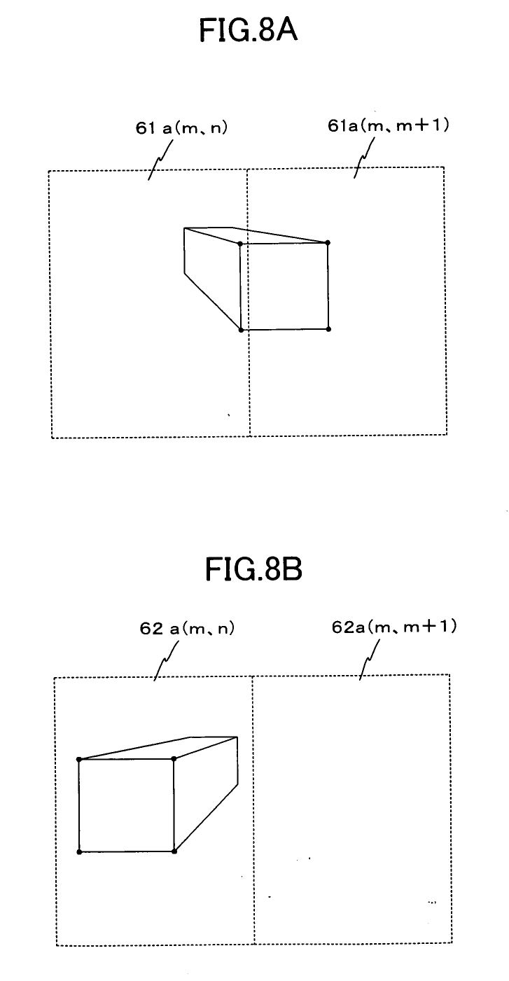

Note that in the embodiment, as can be seen in FIG. 6A or FIG. 6B, the divided image joining unit 17 joins three block images together to create a joined image, but the present invention is not limited to this case, and when a parallax between a characteristic point in the image 61 and a corresponding point in the image 62 is large, greater than or equal to four images may be joined together, and based on this joined image, a matching image may be set. Moreover, as can be seen in FIG. 8A and FIG. 8B, when a building is present across two block images in the image 61 and the building is present within one block image in the image 62, the two block images may be joined together to create a joined image.

Moreover, according to the embodiment, the extracted images 61a and 62a are respectively divided into fifteen block images, but the present invention is not limited to this case, and the extracted images 61a and 62a may be further segmented respectively, and may be divided into less than fifteen block images.

Moreover, in the embodiment, to facilitate the explanation, the explanation has been given of the case where the epipolar line is consistent between the image 61 and the image 62, but when the epipolar line in the image 61 is not consistent with the epipolar line in the image 62, using a technique like one disclosed in Unexamined Japanese Patent Application KOKAI Publication No. 2002-15756, a parallel process that causes corresponding points between the image 61 and the image 62 to be on the same line (e.g., on a line parallel to the X-axis) may be carried out before the process by the image extracting unit 12 is carried out. By carrying out this process, a direction in which a parallax occurs between both images becomes the X-axis direction, and by performing the processes explained in the foregoing embodiment, three-dimensional data can be likewise created.

Moreover, in the embodiment, areas including block images 61a (m, n) and 62a (m, n) and the margin areas M around the block images 61a (m, n) and 62a (m, n) are set as the matching images SMA1 and SMA2, but the present invention is not limited to this case, and without the margin area M, matching images SMA1 and SMA2 having the same size as a divided image may be set. In this case, when a corresponding point corresponding to a characteristic point included in the matching image SMA1 cannot be extracted from the matching image SMA2 corresponding to the matching image SMA1, divided images are joined in a direction in which a parallax occurs, and a matching image is enlarged. Accordingly, it becomes possible to extract a corresponding point corresponding to a characteristic point included in the matching image SMA1 from the matching image SMA2 corresponding to the matching image SMA1 eventually.

Moreover, in the embodiment, the explanation has been given of the case where image data is a pair of image 61 and image 62 picked up by the digital camera 70, but the present invention is not limited to this case, and the image data may be images obtained by digitalizing satellite photographs, or digital images obtained by scanning photographs picked up by a general analog camera.

Moreover, in the embodiment, using the image correlation technique, a corresponding point in the image 62 which corresponds to a characteristic point in the image 61 is extracted, but the present invention is not limited to this case, and other techniques, e.g., one disclosed in Japanese Patent Publication No. H8-16930 may be used.

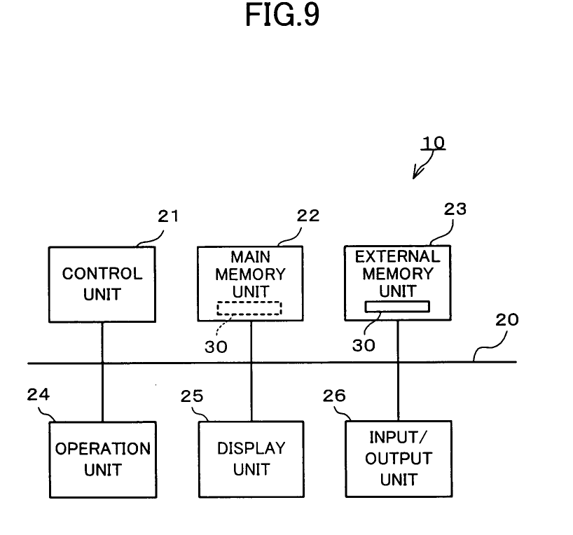

FIG. 9 is a block diagram showing a physical structural example when the stereo image processing apparatus is implemented by a computer. The stereo image processing apparatus 10 of the embodiment can be realized by a hardware structure similar to a general computer apparatus. As shown in FIG. 9, the stereo image processing apparatus 10 has a control unit 21, a main memory unit 22, an external memory unit 23, an operation unit 24, a display unit 25 and input/output unit 26. The main memory unit 22, the external memory unit 23, the operation unit 24, the display unit 25 and the input/output unit 26 are all connected to the control unit 21 via an internal bus 20.

The control unit 21 comprises a CPU (Central Processing Unit) or the like, and executes a stereo matching process in accordance with a control program 30 stored in the external memory unit 23.

The main memory unit 22 comprises a RAM (Random Access Memory) or the like, loads the control program 30 stored in the external memory unit 23, and is used as a work area for the control unit 21.

The external memory unit 23 comprises a non-volatile memory, such as a flash memory, a hard disk, a DVD-RAM (Digital Versatile Disc Random-Access Memory), or DVD-RW (Digital Versatile Disc ReWritable), stores the control program 30 to cause the control unit 21 to execute the foregoing processes, beforehand, supplies data stored by the control program 30 to the control unit 21 in accordance with instructions from the control unit 21 and stores data supplied from the control unit 21.

The operation unit 24 comprises pointing devices, such as a keyboard and a mouse, and interface devices for connecting the keyboard and other pointing devices to the internal bus 20. Inputting of image data, and inputting of an instruction for transmission/reception, or an instruction for an image to be displayed are carried out via the operation unit 24, and are supplied to the control unit 21.

The display unit 25 comprises a CRT (Cathode Ray Tube) or an LCD (Liquid Crystal Display), and displays an image or a result of a stereo matching process.

The input/output unit 26 comprises a wireless communication device, a wireless modem or a network terminal device, and a serial interface or a LAN (Local Area Network) interface connected thereto. Image data is received or a calculated result is transmitted via the input/output unit 26.

The processes of the data input unit 11, the image extracting unit 12, the image dividing unit 13, the matching image setting unit 14, the corresponding point extracting unit 15, the matching-miss detecting unit 16, the divided image joining unit 17, and the three-dimensional information calculating unit 18 of the stereo image processing apparatus 10 shown in FIG. 1 are executed by the control program 30 which executes the processes using the control unit 21, the main memory unit 22, the external memory unit 23, the operation unit 24, the display unit 25 and the input/output unit 26 as resources.

Furthermore, the hardware configuration and the flowchart are merely examples, and can be changed and modified arbitrarily.

A main portion which comprises the control unit 21, the main memory unit 22, the external memory unit 23, the operation unit 24, the input/output unit 26 and the internal bus 20 and which executes the processes of the stereo image processing apparatus 10 is not limited to an exclusive system, and can be realized using a normal computer system. For example, a computer program for executing the foregoing operation may be stored in a computer-readable recording medium (flexible disk, CD-ROM, DVD-ROM or the like) and distributed, and the computer program may be installed in a computer to constitute the stereo image processing apparatus 10 executing the foregoing processes. Moreover, such a computer program may be stored in a storage device of a server device over a communication network like the Internet, and a normal computer system may download the program, thereby constituting the stereo image processing apparatus 10.

When the function of the stereo image processing apparatus 10 is shared by an OS (operating system) and an application program or is realized by the cooperation of the OS and the application program, only the application program portion may be stored in a recording medium or a storage device.

Furthermore, the computer program may be superimposed on a carrier wave, and may be distributed via a communication network. For example, the computer program may be put on a BBS (Bulletin Board System) over a communication network, and the computer program may be distributed via a network. Then, the computer program may be activated, and executed under the control of the OS like the other application programs to achieve a structure which can execute the foregoing processes.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

What is claimed is:

1. An image processing apparatus that performs a stereo matching process on a first image and a second image picked up at mutually different positions, the apparatus comprising:
a setting unit that respectively divides the first image and the second image into plural images, and sets a divided image of the first image and a divided image of the second image, which corresponds to the divided image of the first image, as a first matching image and a second matching image, respectively;
an extracting unit that extracts a corresponding point corresponding to a point in the first matching image and included in the second matching image;
a resetting unit that resets one joined image, which is obtained by joining a divided image set as the first matching image with a different divided image adjoined thereby, as a first matching image and resets another joined image, which is obtained by joining a divided image set as the second matching image with a different divided image adjoined thereby, as a second matching image, when the extracting unit cannot extract the corresponding point; and
a calculating unit that calculates three-dimensional information of a point included in the matching image of the first image, and a corresponding point included in the matching image of the second image.

2. An image processing apparatus that performs a stereo matching process on a first image and a second image picked up at mutually different positions, the apparatus comprising:
a setting unit that respectively divides the first image and the second image into plural images, and sets a divided image of the first image and a margin area therearound, and a divided image of the second image, which corresponds to the divided image of the first image, and a margin area therearound, as a first matching image and a second matching image, respectively;
an extracting unit that extracts a corresponding point corresponding to a point in the first matching image and included in the second matching image;
a resetting unit that resets one joined image, which is obtained by joining a divided image included in the first matching image with a different divided image adjoined thereby, and a margin area surrounding the one joined image as a first matching image and resets another joined image, which is obtained by joining a divided image included in the second matching image with a different divided image adjoined thereby, and a margin area surrounding the another joined image as a second matching image, when the extracting unit cannot extract the corresponding point; and
a calculating unit that calculates three-dimensional information of a point included in the first matching image, and a corresponding point included in the second matching image.

3. The image processing apparatus according to claim 1, wherein the resetting unit joins divided images adjoining in a direction in which a parallax occurs between the first image and the second image.

4. An image processing method that performs a stereo matching process on a first image and a second image picked up at mutually different positions, the method comprising:
a step of dividing the first image and the second image into plural images, respectively, and setting a divided image of the first image and a divided image of the second image, which corresponds to the divided image of the first image, as a first matching image and a second matching image, respectively;
a step of extracting a corresponding point corresponding to a point in the first matching image and included in the second matching image;
a step of resetting one joined image, which is obtained by joining a divided image set as the first matching image with a different divided image adjoined thereby, as a first matching image and resetting another joined image, which is obtained by joining a divided image set as the second matching image with a different divided image adjoined thereby, as a second matching image, when the extracting unit cannot extract the corresponding point; and
a step of calculating three-dimensional information of a point included in the matching image of the first image, and a corresponding point included in the matching image of the second image.

5. An image processing method that performs a stereo matching process on a first image and a second image picked up at mutually different positions, the method comprising:
a step of dividing the first image and the second image into plural images, respectively, and setting a divided image of the first image and a margin area therearound, and a divided image of the second image, which corresponds to the divided image of the first image, and a margin area therearound, as a first matching image and a second matching image, respectively;
a step of extracting a corresponding point corresponding to a point in the first matching image and included in the second matching image;
a step of resetting one joined image, which is obtained by joining a divided image included in the first matching image with a different divided image adjoined thereby, and a margin area surrounding the one joined image as a first matching image and resetting another joined image, which is obtained by joining a divided image included in the second matching image with a different divided image adjoined thereby, and a margin area surrounding the another joined image as a second matching image, when the extracting unit cannot extract the corresponding point; and
a step of calculating three-dimensional information of a point included in the first matching image, and a corresponding point included in the second matching image.

6. A computer-readable recording medium storing a program that allows a computer to function as:
a setting unit that respectively divides a first image and a second image into plural images, the first and second images being picked up at mutually different positions, and sets a divided image of the first image and a divided image of the second image, which corresponds to the divided image of the first image, as a first matching image and a second matching image, respectively;
an extracting unit that extracts a corresponding point corresponding to a point in the first matching image and included in the second matching image;
a resetting unit that resets one joined image, which is obtained by joining a divided image set as the first matching image with a different divided image adjoined thereby, as a first matching image and resets another joined image, which is obtained by joining a divided image set as the second matching image with a different divided image adjoined thereby, as a second matching image, when the extracting unit cannot extract the corresponding point; and
a calculating unit that calculates three-dimensional information of a point included in the matching image of the first image, and a corresponding point included in the matching image of the second image.

7. A computer-readable recording medium storing a program that allows a computer to function as:
a setting unit that respectively divides the first image and the second image into plural images, the first and second images being picked up at mutually different positions, and sets a divided image of the first image and a margin area therearound, and a divided image of the second image, which corresponds to the divided image of the first image, and a margin area therearound, as a first matching image and a second matching image, respectively;
an extracting unit that extracts a corresponding point corresponding to a point in the first matching image and included in the second matching image;
a resetting unit that resets one joined image, which is obtained by joining a divided image included in the first matching image with a different divided image adjoined thereby, and a margin area surrounding the one joined image as a first matching image and resets another joined image, which is obtained by joining a divided image included in the second matching image with a different divided image adjoined thereby, and a margin area surrounding the another joined image as a second matching image, when the extracting unit cannot extract the corresponding point; and
a calculating unit that calculates three-dimensional information of a point included in the first matching image, and a corresponding point included in the second matching image.
